(19) United States
(12) Patent Application Publication
(10) Pub. No.: US 2020/0112829 A1
(43) Pub. Date: Apr. 9, 2020

(54) TRAIL MARKING SYSTEM

(71) Applicant: Leanne Schad, West Seneca, NY (US)

(72) Inventor: Leanne Schad, West Seneca, NY (US)

(21) Appl. No.: 16/595,932

(22) Filed: Oct. 8, 2019

Related U.S. Application Data
(60) Provisional application No. 62/743,125, filed on Oct. 9, 2018.

(51) Int. Cl. H04W 4/024; G06F 16/29; H04W 76/14; H04W 4/029

(52) U.S. Cl. CPC H04W 4/024; G06F 16/29; H04W 88/02; H04W 4/029; H04W 76/14

(57) ABSTRACT

A trail marking system. The system includes trail markers. Each trail marker is placed along a hiking trail or similar path of travel. Each trail marker has a fastener. The fastener can be of any suitable structure for securing each trail marker to a targeted location along the path of travel. Each trail marker includes a controller internally disposed therein. A wireless transceiver is in operable connection with the controller of each trail marker, as well as a global positioning system that is implemented to record a geographic position of each trail marker. The controller, being in operable connection with the wireless transceiver, is designed to broadcast the geographic position to a marker database. Each trail marker also comprises a wireless receiver. The wireless receiver is configured to form a network connection with a mobile device, such that the mobile device location can be recorded by the trail marker.

### CROSS REFERENCE TO RELATED APPLICATIONS

This application claims the benefit of U.S. Provisional Application No. 62/743,125 filed on Oct. 9, 2018. The above identified patent application is herein incorporated by reference in its entirety to provide continuity of disclosure.

### BACKGROUND OF THE INVENTION

The present invention relates to a trail marking system. More specifically, the present invention provides a trail marking system that is designed to track individuals that are hiking via a connection between a plurality of trail markers and a mobile device.

Many people enjoy spending time in nature to relax, explore or otherwise engage in outdoor activities. For example, individuals may enjoy hiking, cycling, camping, backpacking or any other outdoor activity. Commonly, however, the individual may have to travel on hiking trails to engage in these activities. Whether traveling on established hiking trails or on less traveled paths, it is easy for an individual to become lost. This is especially true in natural settings like forests, where brush and trees may obscure the individual's view as they are traveling. When people become lost, it can take them a substantial amount of time to find their way back to their campsite, vehicle or other desired location. Though maps and compasses can be used to locate some places, not every individual is knowledgeable of these devices. Furthermore, in low light settings, it may not be possible for an individual to effectively utilize these devices. Additionally, some hiking trails are outside of the range of cellular phone networks, meaning that a user may not always be able to utilize their mobile device to determine their location.

Therefore, there is a need for a system that will safely and effectively assist individuals who venture into natural settings to keep track of their location while they are traveling. The system should also be configured to provide the location of the individual to a third party.

### SUMMARY OF THE INVENTION

In view of the foregoing disadvantages inherent in the known types of trail marking systems and apparatuses now present in the prior art, the present invention provides a trail marking system wherein the same can be utilized for providing convenience for the user when tracking and sharing the locations of individuals who are traveling on hiking trails or the like.

The present system comprises a plurality of trail markers. Each trail marker of the plurality of trail markers is placed along a hiking trail or similar path of travel. Each trail marker comprises a fastener. The fastener can be of any suitable structure for securing each trail marker to a targeted location along the path of travel. Furthermore, each trail marker comprises a controller internally disposed therein. A wireless transceiver is in operable connection with the controller of each trail marker, as well as a global positioning system that is configured to record a geographic position of each trail marker. The controller, being in operable connection with the wireless transceiver, is configured to broadcast the geographic position to a marker database. Each trail marker also comprises a wireless receiver. The wireless receiver is configured to form a network connection with a mobile device, such that the mobile device location can be recorded by the trail marker.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a block diagram of an embodiment of the trail marking system.

FIG. 2 shows a perspective view of an embodiment of the trail marking system in use.

### DETAILED DESCRIPTION OF THE INVENTION

Reference is made herein to the attached drawings. Like reference numerals are used throughout the drawings to depict like or similar elements of the trail marking system. The figures are intended for representative purposes only and should not be considered to be limiting in any respect.

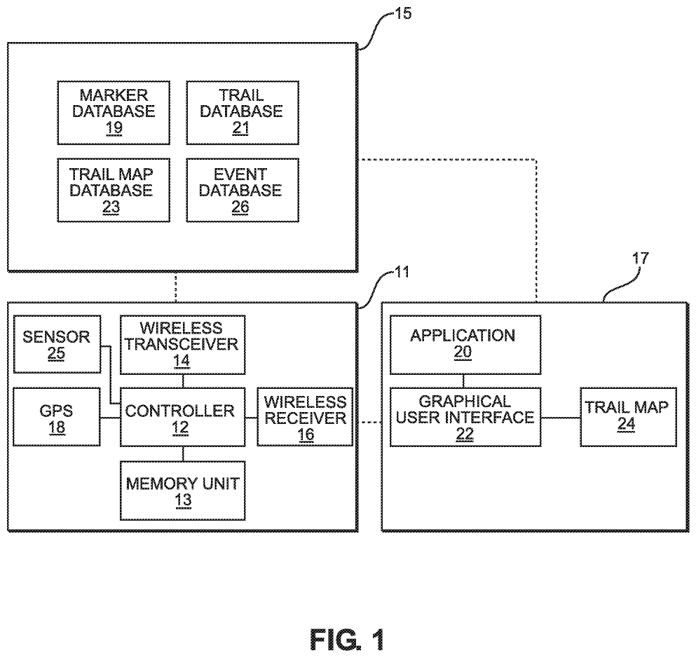

Referring now to FIG. 1, there is shown a block diagram of an embodiment of the trail marking system. The trail marking system comprises a plurality of trail markers 11. Each trail marker of the plurality of trail markers 11 comprises a controller 12. The controller 12 is configured to execute a plurality of commands stored upon a memory unit 13. The memory unit 13 is in operable connection with the controller 12, such that the controller 12 can access processes and databases stored upon the memory unit 13.

Each controller 12 of each trail marker 11 is in further operable connection with a wireless transceiver 14. The wireless transceiver 14 is configured to emit a signal to a server 15. As shown, the server 15 comprises a server memory unit, upon which a marker database 19 is stored. As such, the server 15 provides a record and a communication with each trail marker 11 of the plurality of trail markers. The server 15 is configured to receive the signal from each trail marker 11. As shown, each trail marker 11 of the plurality of trail markers comprises a global positioning system (GPS) 18. As such, a geographic position of each trail marker 11 can be recorded and stored on the memory unit 13 or transmitted to the server 15 via the wireless transceiver 14. The geographic position of each trail marker 11 is recorded in the marker database 19.

Furthermore, each controller 12 of each trail marker 11 is in operable connection with a wireless receiver 16. The wireless receiver 16 is configured to form a network connection with a mobile device 17, such as a mobile phone or a similar device. In the illustrated embodiment, the mobile device 17 comprises an application 20 stored thereon. The application 20 is configured to be executable by the mobile device 17 and to utilize the mobile device 17 to form a network connection with the server 15. The application 20 comprises a graphical user interface 22, such that the mobile device 17 can provide a viewable arrangement of data received from the server 15. As such, the mobile device 17 can download and utilize a trail database 21 stored on the server 15.

The trail database 21 comprises trail data from a trail or other path of travel. For example, the trail database 21 may comprise a difficulty level of each trail, a list of geographic attraction locations on each trail, or any other recordable data associated with each trail. In some embodiments, the server 15 further comprises a trail map database 23. As such, the application 20 may download and provide a trail map 24 from the server 15 on the graphical user interface 22. The trail map 24 is configured to provide each user with a path on which to follow when hiking or engaging in another outdoor activity. In conjunction with the global positioning system 18 of the plurality of trail markers 11 and with the global positioning system of the mobile device 17 itself, the individual will be able to track their location on the trail map 24 on the graphical user interface 22 in real time. Additionally, in alternate embodiments, the individual will also be able to share their location in real time with other individuals who have downloaded the application 20. The individual may also utilize the application 20 to share his or her location on a third-party application, such as a social media application or a communication application.

In some embodiments, each trail marker 11 of the plurality of trail markers comprises a sensor 25 embedded therein. The sensor 25 is configured to detect a presence of an individual in a vicinity of the trail marker 11. The sensor 25 may be of any suitable configuration for detecting the presence of an individual. For example, the sensor 25 may be a passive infrared sensor configured to detect the heat signature of a human. The sensor 25 is in operable connection with the controller 12 of the trail marker 11, such that when the sensor 25 detects the presence of a human, it is transmitted via the wireless transceiver 14 to the server 15 and stored on an event database 26. In the event that an individual is being searched for, the sensor data may be utilized to assist emergency personnel in locating the individual.

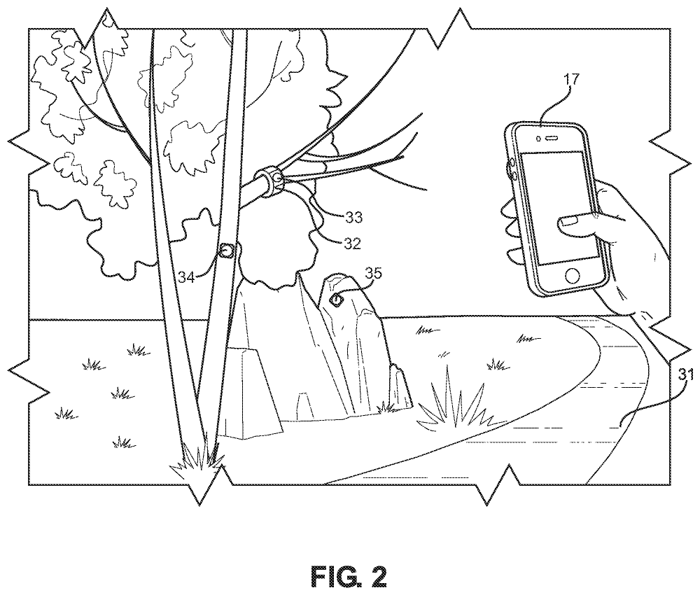

Referring now to FIG. 2, there is shown a perspective view of an embodiment of the trail marking system in use. In use, the plurality of trail markers 33, 34, 35 are installed along hiking trails 31 or other pathways of travel. As such, traffic along the hiking trails 31 can be monitored, in addition to allowing individuals with the application on their mobile device 17 to plan their route, track their progress and share their location data.

Structurally, each trail marker comprises a fastener configured to secure the trail marker to a desired location. The fastener may be of any suitable configuration for securing the trail marker. In the illustrated embodiment, a first trail marker 33, a second trail marker 34 and a third trail marker 35 are shown. The first trail marker 33 is disposed on a tree limb. In some embodiments, the trail marker comprises a band 32 configured to secure the trail marker around a columnar object, such as a tree limb, trail post, or similar structure. In further embodiments, the second and third trail markers use alternate fastening means, such as an adhesive.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A trail marking system, comprising:
a plurality of trail markers;
each trail marker of the plurality of trail markers comprising a fastener;
each trail marker comprising a controller disposed therein;
each controller in operable connection with a memory unit;
a wireless transceiver in operable connection with the controller and with a server;
each trail marker comprising a global positioning system;
the global positioning system configured to record a geographic position of each trail marker;
the controller configured to broadcast the geographic position to a location receiver via the wireless transceiver to a marker database stored on the server;
the controller in operable connection with a wireless receiver;
each wireless receiver configured to form a network connection with a mobile device.

2) The trail marking system of claim 1, further comprising an application stored upon the mobile device, wherein the application is executable by the mobile device.

3) The trail marking system of claim 2, wherein the application is programmed with a trail database stored on the server.

4) The trail marking system of claim 3, wherein each trail in the trail database is assigned a difficulty level.

5) The trail marking system of claim 2, wherein the application is programmed to receive a plurality of trail maps from a trail map database on the server.

6) The trail marking system of claim 1, wherein each trail marker of the plurality of trail markers comprises a sensor, wherein the sensor is configured to detect an individual.

7) The trail marking system of claim 6, wherein each sensor is a passive infrared sensor configured to detect a heat signature of a human.

8) The trail marking system of claim 1, wherein each controller is programmed to allow access to the geographic location of each trail marker via an access code.

9) The trail marking system of claim 1, wherein the fastener comprises a band configured to encircle a columnar structure.

10) The trail marking system of claim 1, wherein the fastener comprises an adhesive configured to engage a natural structure.
